(19) United States
(12) Patent Application Publication
(10) Pub. No.: US 2014/0316827 A1
(43) Pub. Date: Oct. 23, 2014

(54) Method, System and Program Product for a Linked Dispatch System

(71) Applicant: Charbel Ishak, Oakville (CA)

(72) Inventor: Charbel Ishak, Oakville (CA)

(21) Appl. No.: 14/046,959

(22) Filed: Oct. 5, 2013

Related U.S. Application Data
(60) Provisional application No. 61/814,012, filed on Apr. 19, 2013.

(51) Int. Cl. G06Q 10/02

(52) U.S. Cl. CPC G06Q 10/02
USPC 705/5

(57) ABSTRACT

A method, system and program product comprises placing a reservation request for a service for a recipient. The reservation request is communicated to a server. The server is configured to be operable to select a provider from a group of providers associated with the recipient. The server is further configured to determine that a selected provider satisfies guidelines of the reservation, communicate the reservation request to a selected provider satisfying the guidelines, select another provider upon rejection of, or a failure to accept, the reservation request by the selected provider, and provide notification of acceptance of the reservation request. The notification is received from the server.

### CROSS-REFERENCE TO RELATED APPLICATIONS

The present Utility patent application claims priority benefit of the U.S. provisional application for patent Ser. No. 61/814,012 filed on Apr. 19, 2013 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to managing provision of services. More particularly, the invention relates to managing provision of services through determining availability of service providers.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Though people often require taxis and other services, many currently available options for requesting such services may ineffectively manage interaction between service providers and recipients, and may fail to provide valuable incentives to both providers and recipients.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One aspect of the prior art shows systems, methods, and computer program products which are provided for matching a passenger with a driver for a trip to a destination. By way of educational background, another aspect of the prior art generally useful to be aware of is a system and method for providing taxi patrons with a taxi-reservation system which facilitates better taxi service, better time utilization and financial rewards for taxi drivers who provide better service, and more efficient pricing for buyers. By way of educational background, another aspect of the prior art discloses of a mobile taxi dispatch system which may receive a request for a taxi vehicle from a user, select one or more taxi vehicles to contact in response to receiving the request, and send the request to the selected one or more taxi vehicles. However, these solutions may not offer suitably valuable services and incentives to create a desirable system for consumers.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary system for interaction between providers of services and recipients of services, in accordance with an embodiment of the present invention;

FIG. 2 illustrates an exemplary method for user registration, in accordance with an embodiment of the present invention;

FIG. 3 illustrates another exemplary method for user association during registration process, in accordance with an embodiment of the present invention;

FIG. 4 illustrates an exemplary method for adding users to a group, in accordance with an embodiment of the present invention;

FIG. 5 illustrates an exemplary method for making a reservation, in accordance with an embodiment of the present invention;

FIG. 6 illustrates an exemplary method for sending a request to a provider 105, in accordance with an embodiment of the present invention;

FIG. 7 is a block diagram depicting an exemplary client/server system which may be used by an exemplary web-enabled/networked embodiment of the present invention; and

FIG. 8 illustrates a block diagram depicting a conventional client/server communication system.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

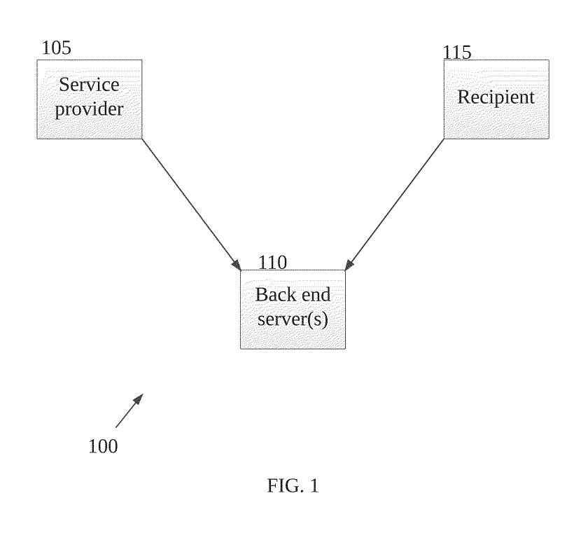

FIG. 1 illustrates an exemplary system for interaction between providers of services and recipients of services, in accordance with an embodiment of the present invention. In the present embodiment, a service provider 105 may access computer software to provide and receive electronic information. In some embodiments, computer software may be in any form, including, without limitation, a mobile application, a website, or an independent computing system. In the present embodiment, a provider 105 may access software to perform a variety of functions, including, without limitation: registering and managing login information; creating and updating profile information; creating and managing a group of associates; communicating with other users through back end server 110; providing availability and/or location information; receiving updates and/or notifications; receiving and providing payments; receiving and providing billing information; and accessing historical information. In the present embodiment, a recipient 115 of services may use the software for a variety of reasons, including, without limitation: creating and managing a group of service providers 105; adding and updating provider 105 identifying information; creating and managing a group of recipients 115; creating and updating personal profile information; creating and updating a special needs list; creating and managing reservation requests; attaching location information to profile and/or reservation requests; receiving information about providers 105; receiving pricing information; tracking location of providers 105; making and managing payments; receiving notifications from back end server 110; and receiving promotion information. In the present embodiment, a back end server 110 may serve a variety of functions, including, without limitation: maintaining a list of providers 105; selecting relevant servers 110; storing and maintaining recipient 115 information in databases; storing and maintaining provider 105 information in databases; storing and maintaining provider 105 equipment information in databases; storing and maintaining information on groups of providers 105 and/or recipients 115 in databases; authenticating user login information; managing information regarding provider 105 availability and location; receiving reservation requests; and processing dispatch requests. The term “user” may refer to both providers 105 and recipients 115.

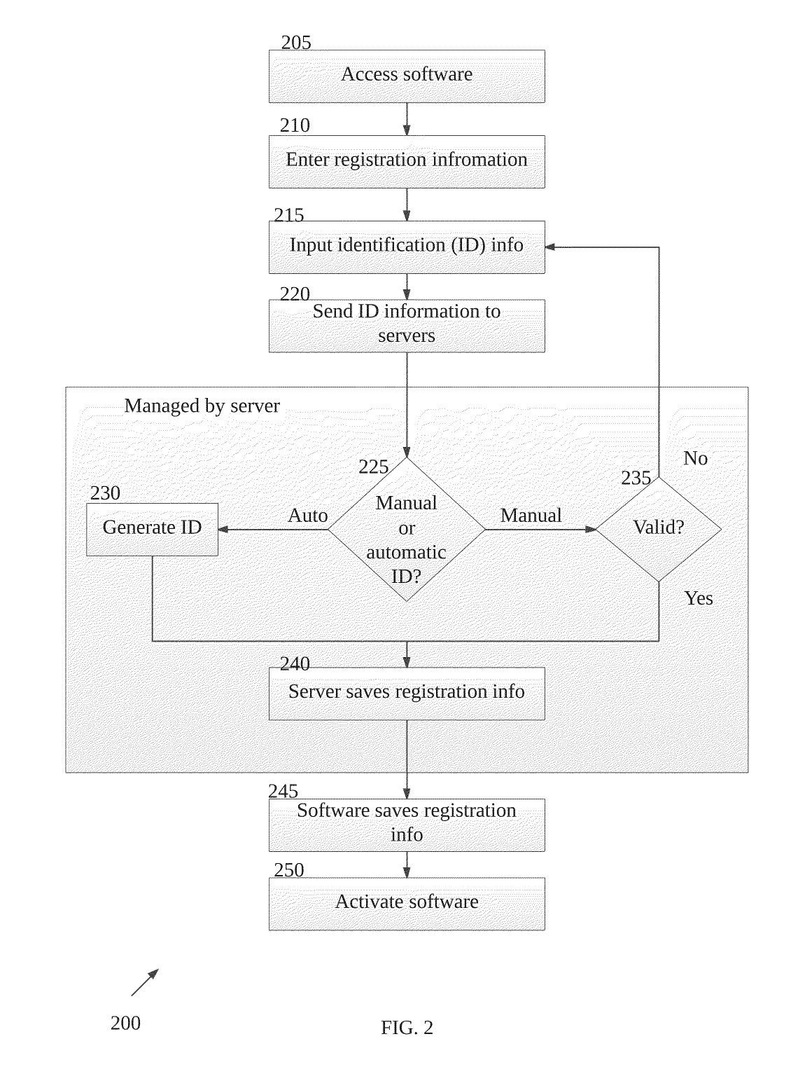

FIG. 2 illustrates an exemplary method for user registration, in accordance with an embodiment of the present invention. In the present embodiment, user may access computer software in a step 205. In some embodiments, accessing software may include, without limitation, downloading and installing an application. In the present embodiment, user may enter registration information in a step 210. In some embodiments, registration information may include, without limitation, geographic regions, types of services performed, profile images, and availability details. In the present embodiment, software may prompt user to either manually input identification (ID) information or request an automatically generated ID in a step 215. In some embodiments, user IDs may be unique within a determined operation region. In a non-limiting example, a provider 105 working in Los Angeles may be required to register an ID that is unique in Los Angeles, but the provider 105 may not be required to register an ID that is unique outside of Los Angeles. In some embodiments, software may have a validation / verification process for any inputted IDs. In the present embodiment, software may send ID information to servers 110 in a step 220. In the present embodiment, server may determine whether user has chosen to manually input an ID or to allow an automatically generated ID in a step 225. Further, in the present embodiment, if user has chosen to allow an automatically generated ID, server may generate an ID in a step 230. In the present embodiment, if user has selected to manually input an ID, server may determine whether manually inputted ID is valid in a step 235. Further, in the present embodiment, if manually inputted ID is not valid, software may again prompt user for an ID in a step 215. In the present embodiment, if the manually inputted ID is valid, server may save user registration information and/or send a confirmation in a step 240. In some embodiments, saved registration information may include, without limitation, user ID and geographic locations. In the present embodiment, user-accessed computer software may save user ID and/or registration information in a step 245. In the present embodiment, computer software may be activated in a step 250.

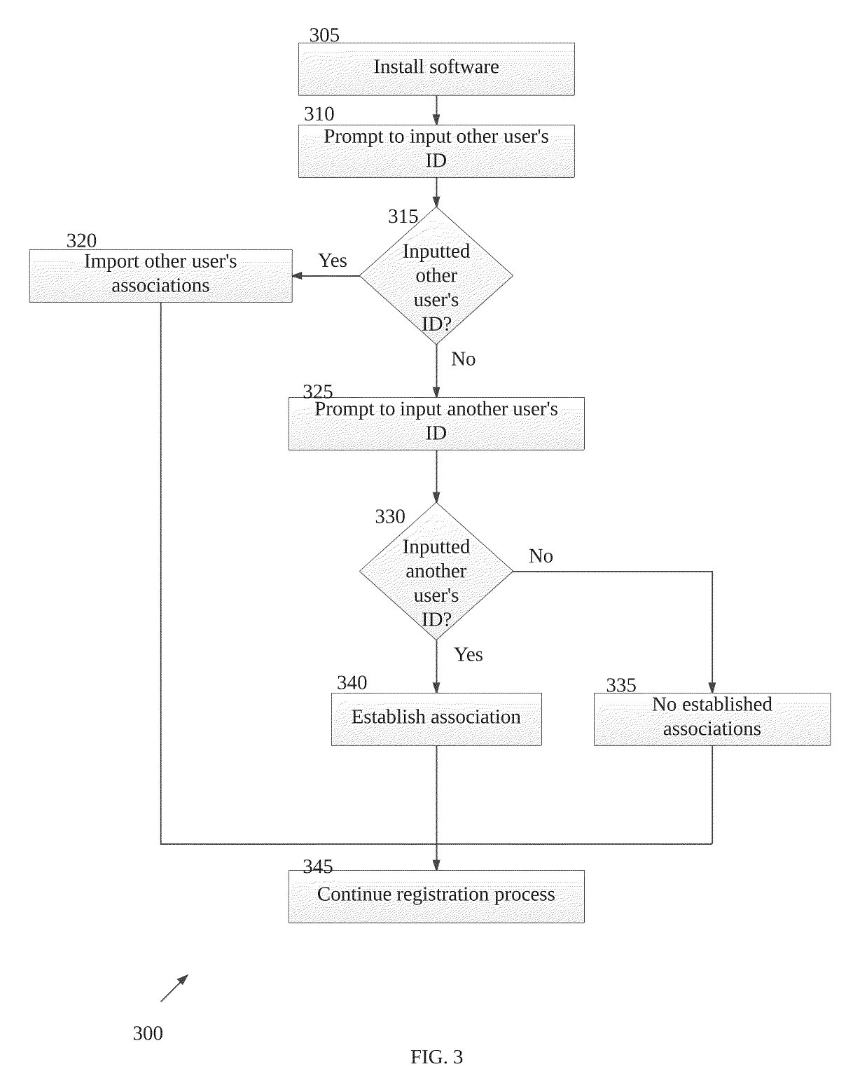

FIG. 3 illustrates another exemplary method for user association during registration process, in accordance with an embodiment of the present invention. In the present embodiment, a user may install computer software in a step 305. Further, in the present embodiment, software may prompt user to input a second user's ID in a step 310. In some embodiments, a first user may input an ID of a second user as an association/referral ID. In the present embodiment, software may determine whether user has inputted a second user's ID in a step 315. In the present embodiment, if first user inputs second user's ID, software may provide first user with any IDs associated with second user in a step 320. In a non-limiting example, a recipient 115 may have a provider 105 associated with recipient's 115 account. In the present non-limiting example, if first recipient 115 provides first recipient's 115 ID to a second recipient 115, second recipient 115 may inherit association with provider 105 by inputting first recipient's 115 ID during registration process. In the present embodiment, if user has not inputted a second user's ID, software may prompt user to input a third user's ID in a step 325. In a non-limiting example in which a recipient 115 may register to use software, software may, during registration process, prompt a recipient 115 to input a second recipient's 115 ID to inherit second recipient's 115 associations. In the present non-limiting example, if recipient 115 has not provided a second recipient's 115 ID, software may then prompt recipient 115 to input a provider's 105 ID to establish an association with the provider 105. In the present embodiment, software may determine whether user has inputted a third user's ID in a step 330. Further, in the present embodiment, if user has not inputted a third user's ID, user may not be associated with any other users in a step 335. In the present embodiment, if user has inputted a third user's ID, software may save provided third user's ID and/or create an association between first and third user in a step 340. In some embodiments, software may reserve part of a user's profile information for “shared” or “sharing” IDs. In some of these embodiments, if user has been associated with a second and/or third user, the second and/or third user's IDs may be saved in “shared” or “sharing” ID location. Further, in some of these embodiments, if first user has not been associated with other users, first user's personal ID may be saved is user's “shared” or “sharing” ID location. In other embodiments, if user has not been associated with other users, a default ID may be saved in user's “shared” or “sharing” ID location. In the present embodiment, software may allow user to continue registration process in a step 345.

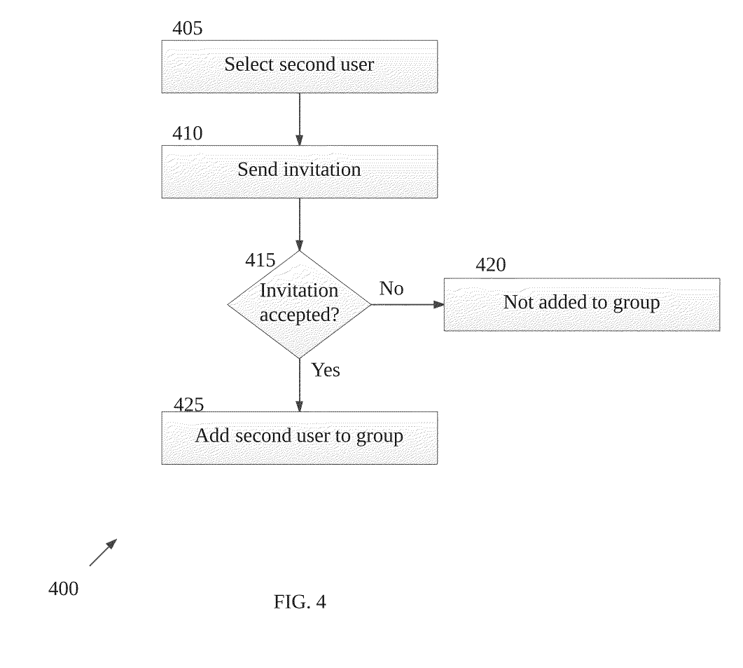

FIG. 4 illustrates an exemplary method for adding users to a group, in accordance with an embodiment of the present invention. In the present embodiment, a first user may select a second user in a step 405. In the present embodiment, first user may send an invitation to second user in a step 410. In some embodiments, invitation may include, without limitation, a text and/or video message. In the present embodiment, software may determine whether second user has accepted first user's invitation in a step 415. In the present embodiment, if second user has accepted first user's invitation, software may add second user to at least one of user's groups in a step 425. In some embodiments, software may send first user an acceptance message when others users have been added to at least one of first user's groups. In the present embodiment, if second user has not accepted first user's invitation, software may not add second user to at least one of user's groups in a step 420. In some embodiments, software may send a rejection message to first user when other users reject an invitation from first user. In many embodiments, a first user may delete other users from first user's groups. In some of these embodiments, software may send a notification message to a user if the user has been deleted from a group.

In some embodiments, recipients 115 may access software to make reservation requests for a service from providers 105. In some of these embodiments, software may have default reservation guidelines which may need to be satisfied before a reservation may be made. In some embodiments, default reservation guidelines may include, without limitation: geographic proximity between provider 105 and recipient 115; reservation restrictions associated with relevant provider 105 and/or recipient 115; recipient's 115 location being within provider's 105 service radius; and current availability of provider 105.

In some embodiments, providers 105 may have preferences for algorithms by which servers 110 may handle requests made to provider 105. In a non-limiting example, various algorithms may include, without limitation: forwarding any requests to a company which provider 105 may determine; accepting request only if default reservation guidelines are met for provider 105, and otherwise forwarding request to a determined company; accepting request only if default reservation guidelines are met for selected provider 105, and otherwise forwarding request to providers 105 within selected provider's 105 group; and forwarding to a determined other provider 105. In some embodiments, server may have a default selection algorithm which server 110 may apply when a selected provider 105 has not set up a preferred algorithm.

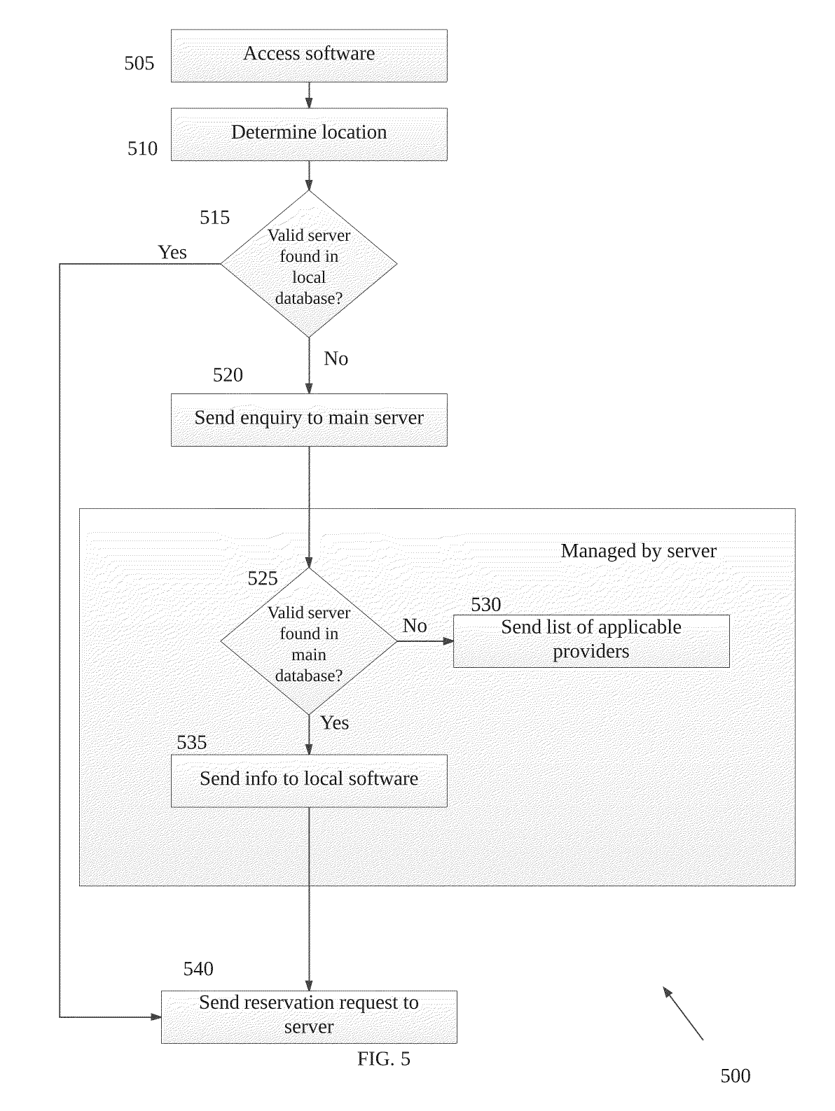

FIG. 5 illustrates an exemplary method for making a reservation, in accordance with an embodiment of the present invention. In the present embodiment, recipient 115 may access computer software in a step 505. Further, in the present embodiment, software may determine recipient's 115 location and/or an operating region associated with determined location in a step 510. In some embodiments, software may use any suitable location services, including, without limitation, global positioning systems (GPS). In the present embodiment, software may determine whether a server 110 representing determined operating region and/or location may be found in software's local database in a step 515. Further, in the present embodiment, if a matching server 110 has not been found in software's local database, software may send an enquiry to a main server 110 in a step 520. In some embodiments, enquiry may include, without limitation, determined operating region and/or location. In the present embodiment, main server 110 may receive enquiry and determine whether a matching server exists in a step 525. In some embodiments, main server 110 may access a database to locate servers 110. In the present embodiment, if no matching server has been found, main server 110 may send a list of providers 105 serving determined operating region and/or location in a step 530. In some embodiments, list of providers 105 may include, without limitation, provider's 105 name and telephone number. In the present embodiment, if main server 110 has found a matching server 110, main server 110 may send information regarding found server 110 to user's local software in a step 535. Further, in the present embodiment, local software may send reservation information to found server 110 in a step 540. In some embodiments, reservation information may include, without limitation, any IDs associated with request.

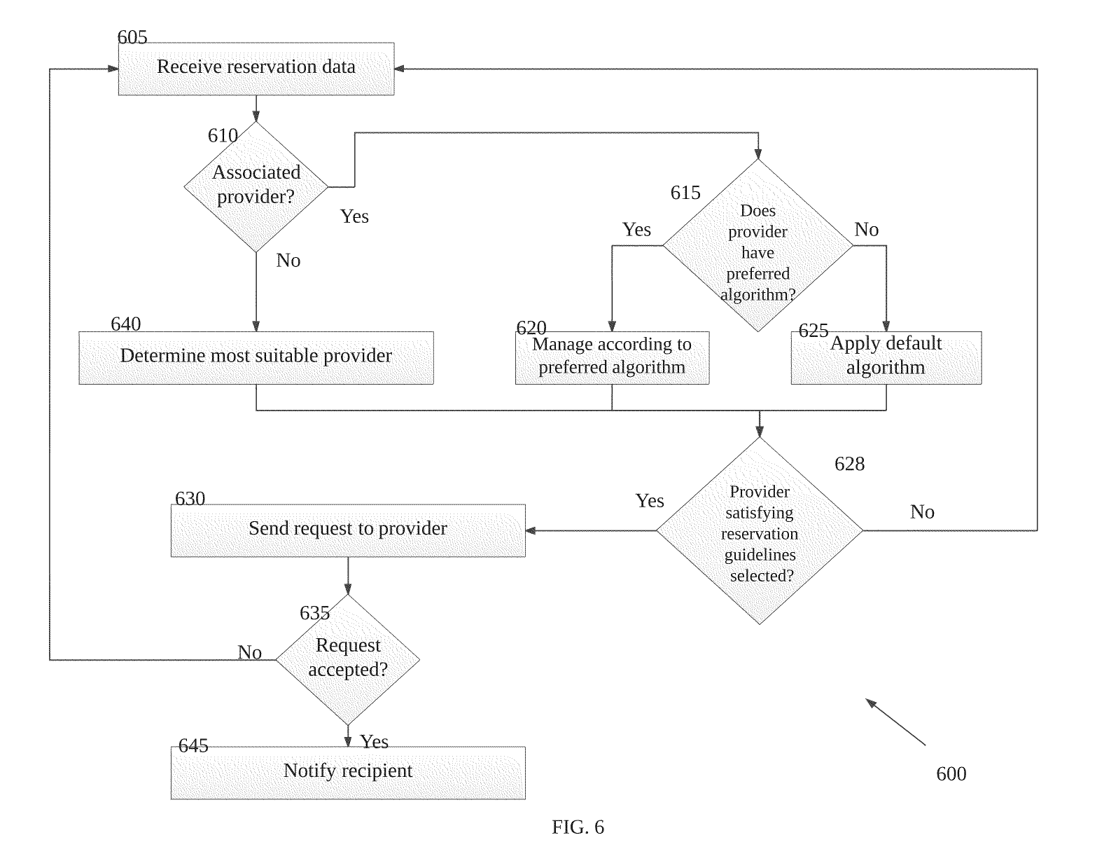

FIG. 6 illustrates an exemplary method for sending a request to a provider 105, in accordance with an embodiment of the present invention. In the present embodiment, a server 110 may receive reservation data in a step 605. Server 110 may provide a highest priority to a main linked provider associated with recipient 115. Further, in the present embodiment, server may determine whether a provider 105 is associated with reservation request in a step 610. If provider 105 is not associated, server may select a best suitable provider in a step 640, or may elect to forward the call to a best suitable provider on file. Still further, in the present embodiment, if a provider 105 is associated with reservation request, server may determine whether provider 105 has a preferred algorithm for handling reservation requests in a step 615. In some embodiments, providers 105 may manually create any preferred algorithm or select a pre-made algorithm from a list. In the present embodiment, if provider 105 has a preferred algorithm, server may manage request in accordance with provider's 105 preferred algorithm in a step 620. Further, in the present embodiment, if provider 105 does not have a preferred algorithm, server may apply a default algorithm in a step 625. In a step 628 server 110 may determine if provider 105 satisfies reservation guidelines. Reservation guidelines may include, without limitation: geographic proximity between provider 105 and recipient 115; reservation restrictions associated with relevant provider 105 and/or recipient 115; recipient's 115 location being within provider's 105 service radius; and current availability of provider 105. If provider 105 does not satisfy the reservation guidelines, server 110 may select another linked or associated provider. Still further, in the present embodiment, after server has determined a provider 105, server may send a request to the provider 105 in a step 630. In some embodiments, a request may be in any form, including, without limitation, phone call, text message, email, or notification. In the present embodiment, software may determine whether provider 105 has accepted request in a step 635. In the present embodiment, if selected provider 105 does not accept request, server 110 may select a next most suitable provider 105. In the present embodiment, if selected provider 105 accepts request, server may notify recipient 115 in a step 645. In a non-limiting example, a customer places an order for a cab using his app, the backend system checks to see if the linked driver is capable of servicing the call (meets all requirements, such as distance, availability etc. . . . ). If so the call will be dispatched to the associated driver. However if the main linked driver is not capable of servicing the call, the system attempts to dispatch the call to the best suitable driver within the linked drivers group. If the system fails to select a driver from the drivers group, it will default to the best suitable vehicle/driver available, or may elect to forward the call to the best suitable service provider on file.

In some embodiments, providers 105 may receive rewards for forwarding jobs to other providers 105. In a non-limiting example, if a first provider 105 forwards a request to a second provider 105 within a group of the first provider 105 and the second provider 105 accepts the request, the first provider 105 may receive a reward. In the present non-limiting example, if the second provider 105 chooses to forward the request to a third provider 105 within a group of the second provider 105 and the third provider 105 accepts the request, both the first provider 105 and the second provider 105 may receive a reward. Process outlined in the above non-limiting example may continue indefinitely with any number of providers 105 and any number of groups.

In many embodiments, software may compile and manage any complaints from recipients 115 regarding providers 105. In a non-limiting example, a server 110 may automatically forward complaints from a recipient 115 to a provider 105 associated with the recipient 105.

In some embodiments, users may have a variety of information about other users. In a non-limiting example, a provider 105 may be provided with details regarding how a recipient 115 may have been forwarded to the provider 105, as well as historical information about the recipient 115, including, without limitation, what providers 105 may have serviced the recipient 115, how often the recipient 115 may have received services, and any complaints lodged by recipient 115. In some embodiments, information that may be provided may include, without limitation, the association / relation between the user and the provider. For example, but not limited to, directly linked customer, or inherited, or no relation at all.

In many embodiments, recipients 115 may receive rewards by referring other recipients to software and/or providers 105. In a non-limiting example, if a first recipient 115 provides an ID of the first recipient 115 to a second recipient 115 and the second recipient uses the ID of the first recipient 115 during registration process, the first recipient 115 may receive a reward.

In many embodiments, recipient may be linked to individual provider profiles. Providers may create provider groups to service linked recipients. The system may link recipient to recipient through the usage of an ID system. The system may create recipient pyramids attached to a provider profile. The system may provide the tools that allow a recipient to delete his current association with a provider and select a different provider to be associated with. The system may create recipient pyramids attached to a recipient profile. The system may reward recipients based on service requests by corresponding pyramid members. The system may allow providers to select at any time a favorite algorithm to better service linked recipient. The system may allow providers to setup automatic selection of a default algorithm based on current provider's status. The system may reward providers by providing them the highest priority to service linked recipients. The system may reward providers through the usage of a revenue sharing algorithm by passing a linked recipient order to a member in the related provider's group. The system may allow providers to prioritize selection within the attached provider's group. The system may provide a tool to forward recipient complaints about an indirectly linked provider group member to a main linked provider. The system may provide programmable pyramid compensation levels.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

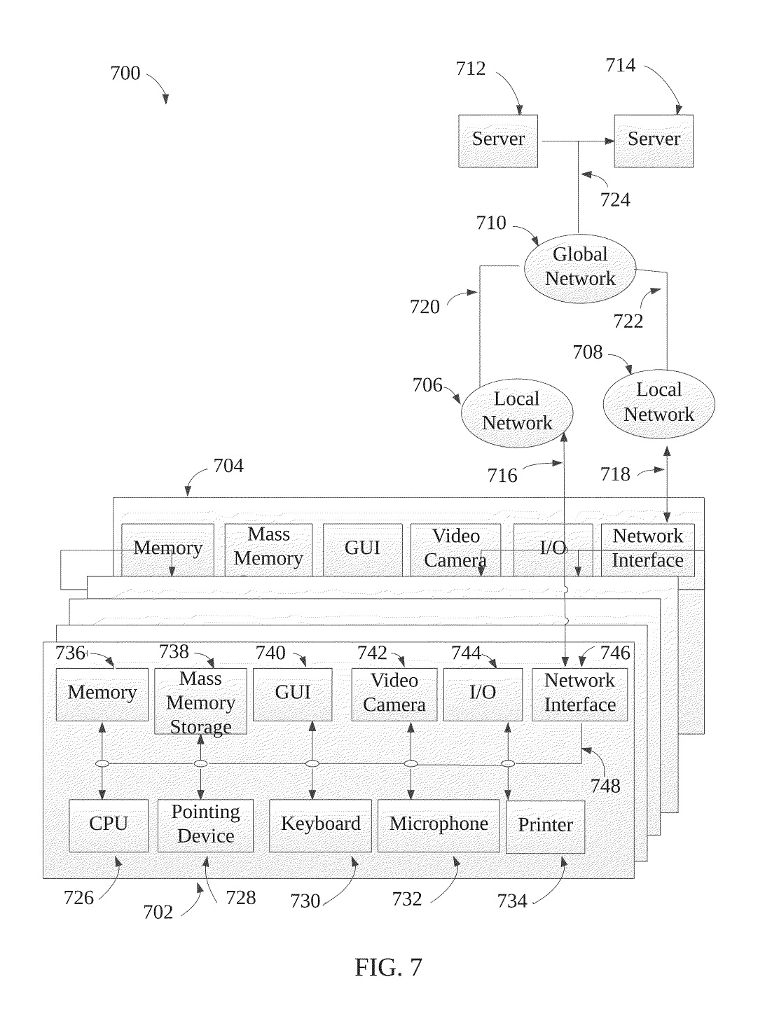

FIG. 7 is a block diagram depicting an exemplary client/server system which may be used by an exemplary web-enabled/networked embodiment of the present invention.

A communication system 700 includes a multiplicity of clients with a sampling of clients denoted as a client 702 and a client 704, a multiplicity of local networks with a sampling of networks denoted as a local network 706 and a local network 708, a global network 710 and a multiplicity of servers with a sampling of servers denoted as a server 712 and a server 714.

Client 702 may communicate bi-directionally with local network 706 via a communication channel 716. Client 704 may communicate bi-directionally with local network 708 via a communication channel 718. Local network 706 may communicate bi-directionally with global network 710 via a communication channel 720. Local network 708 may communicate bi-directionally with global network 710 via a communication channel 722. Global network 710 may communicate bi-directionally with server 712 and server 714 via a communication channel 724. Server 712 and server 714 may communicate bi-directionally with each other via communication channel 724. Furthermore, clients 702, 704, local networks 706, 708, global network 710 and servers 712, 714 may each communicate bi-directionally with each other.

In one embodiment, global network 710 may operate as the Internet. It will be understood by those skilled in the art that communication system 700 may take many different forms. Non-limiting examples of forms for communication system 700 include local area networks (LANs), wide area networks (WANs), wired telephone networks, wireless networks, or any other network supporting data communication between respective entities.

Clients 702 and 704 may take many different forms. Non-limiting examples of clients 702 and 704 include personal computers, personal digital assistants (PDAs), cellular phones and smartphones.

Client 702 includes a CPU 726, a pointing device 728, a keyboard 730, a microphone 732, a printer 734, a memory 736, a mass memory storage 738, a GUI 740, a video camera 742, an input/output interface 744 and a network interface 746. CPU 726, pointing device 728, keyboard 730, microphone 732, printer 734, memory 736, mass memory storage 738, GUI 740, video camera 742, input/output interface 744 and network interface 746 may communicate in a unidirectional manner or a bi-directional manner with each other via a communication channel 748. Communication channel 748 may be configured as a single communication channel or a multiplicity of communication channels.

CPU 726 may be comprised of a single processor or multiple processors. CPU 726 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 736 is used typically to transfer data and instructions to CPU 726 in a bi-directional manner. Memory 736, as discussed previously, may include any suitable computer-readable media, intended for data storage, such as those described above excluding any wired or wireless transmissions unless specifically noted. Mass memory storage 738 may also be coupled bi-directionally to CPU 726 and provides additional data storage capacity and may include any of the computer-readable media described above. Mass memory storage 738 may be used to store programs, data and the like and is typically a secondary storage medium such as a hard disk. It will be appreciated that the information retained within mass memory storage 738, may, in appropriate cases, be incorporated in standard fashion as part of memory 736 as virtual memory.

CPU 726 may be coupled to GUI 740. GUI 740 enables a user to view the operation of computer operating system and software. CPU 726 may be coupled to pointing device 728. Non-limiting examples of pointing device 728 include computer mouse, trackball and touchpad. Pointing device 728 enables a user with the capability to maneuver a computer cursor about the viewing area of GUI 740 and select areas or features in the viewing area of GUI 740. CPU 726 may be coupled to keyboard 730. Keyboard 730 enables a user with the capability to input alphanumeric textual information to CPU 726. CPU 726 may be coupled to microphone 732. Microphone 732 enables audio produced by a user to be recorded, processed and communicated by CPU 726. CPU 726 may be connected to printer 734. Printer 734 enables a user with the capability to print information to a sheet of paper. CPU 726 may be connected to video camera 742. Video camera 742 enables video produced or captured by user to be recorded, processed and communicated by CPU 726.

CPU 726 may also be coupled to input/output interface 744 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 726 optionally may be coupled to network interface 746 which enables communication with an external device such as a database or a computer or telecommunications or internet network using an external connection shown generally as communication channel 716, which may be implemented as a hardwired or wireless communications link using suitable conventional technologies. With such a connection, CPU 726 might receive information from the network, or might output information to a network in the course of performing the method steps described in the teachings of the present invention.

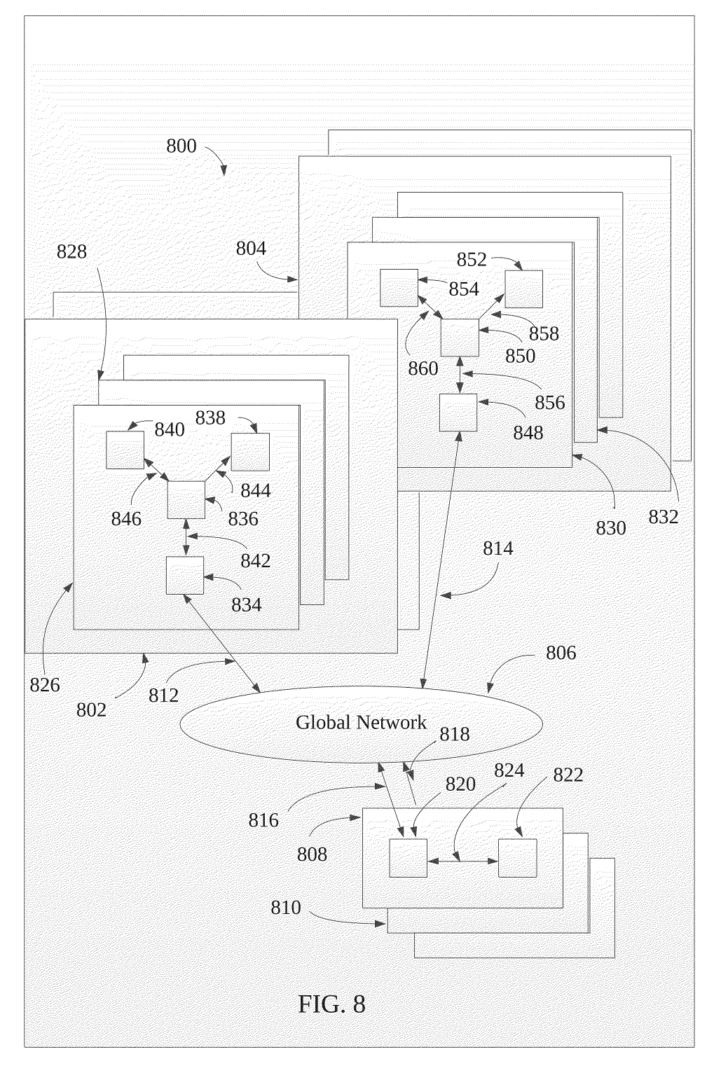

FIG. 8 illustrates a block diagram depicting a conventional client/server communication system.

A communication system 800 includes a multiplicity of networked regions with a sampling of regions denoted as a network region 802 and a network region 804, a global network 806 and a multiplicity of servers with a sampling of servers denoted as a server device 808 and a server device 810.

Network region 802 and network region 804 may operate to represent a network contained within a geographical area or region. Non-limiting examples of representations for the geographical areas for the networked regions may include postal zip codes, telephone area codes, states, counties, cities and countries. Elements within network region 802 and 804 may operate to communicate with external elements within other networked regions or within elements contained within the same network region.

In some implementations, global network 806 may operate as the Internet. It will be understood by those skilled in the art that communication system 800 may take many different forms. Non-limiting examples of forms for communication system 800 include local area networks (LANs), wide area networks (WANs), wired telephone networks, cellular telephone networks or any other network supporting data communication between respective entities via hardwired or wireless communication networks. Global network 806 may operate to transfer information between the various networked elements.

Server device 808 and server device 810 may operate to execute software instructions, store information, support database operations and communicate with other networked elements. Non-limiting examples of software and scripting languages which may be executed on server device 808 and server device 810 include C, C++, C# and Java.

Network region 802 may operate to communicate bi-directionally with global network 806 via a communication channel 812. Network region 804 may operate to communicate bi-directionally with global network 806 via a communication channel 814. Server device 808 may operate to communicate bi-directionally with global network 806 via a communication channel 816. Server device 810 may operate to communicate bi-directionally with global network 806 via a communication channel 818. Network region 802 and 804, global network 806 and server devices 808 and 810 may operate to communicate with each other and with every other networked device located within communication system 800.

Server device 808 includes a networking device 820 and a server 822. Networking device 820 may operate to communicate bi-directionally with global network 806 via communication channel 816 and with server 822 via a communication channel 824. Server 822 may operate to execute software instructions and store information.

Network region 802 includes a multiplicity of clients with a sampling denoted as a client 826 and a client 828. Client 826 includes a networking device 834, a processor 836, a GUI 838 and an interface device 840. Non-limiting examples of devices for GUI 838 include monitors, televisions, cellular telephones, smartphones and PDAs (Personal Digital Assistants). Non-limiting examples of interface device 840 include pointing device, mouse, trackball, scanner and printer. Networking device 834 may communicate bi-directionally with global network 806 via communication channel 812 and with processor 836 via a communication channel 842. GUI 838 may receive information from processor 836 via a communication channel 844 for presentation to a user for viewing. Interface device 840 may operate to send control information to processor 836 and to receive information from processor 836 via a communication channel 846. Network region 804 includes a multiplicity of clients with a sampling denoted as a client 830 and a client 832. Client 830 includes a networking device 848, a processor 850, a GUI 852 and an interface device 854. Non-limiting examples of devices for GUI 838 include monitors, televisions, cellular telephones, smartphones and PDAs (Personal Digital Assistants). Non-limiting examples of interface device 840 include pointing devices, mousse, trackballs, scanners and printers. Networking device 848 may communicate bi-directionally with global network 806 via communication channel 814 and with processor 850 via a communication channel 856. GUI 852 may receive information from processor 850 via a communication channel 858 for presentation to a user for viewing. Interface device 854 may operate to send control information to processor 850 and to receive information from processor 850 via a communication channel 860.

For example, consider the case where a user interfacing with client 826 may want to execute a networked application. A user may enter the IP (Internet Protocol) address for the networked application using interface device 840. The IP address information may be communicated to processor 836 via communication channel 846. Processor 836 may then communicate the IP address information to networking device 834 via communication channel 842. Networking device 834 may then communicate the IP address information to global network 806 via communication channel 812. Global network 806 may then communicate the IP address information to networking device 820 of server device 808 via communication channel 816. Networking device 820 may then communicate the IP address information to server 822 via communication channel 824. Server 822 may receive the IP address information and after processing the IP address information may communicate return information to networking device 820 via communication channel 824. Networking device 820 may communicate the return information to global network 806 via communication channel 816. Global network 806 may communicate the return information to networking device 834 via communication channel 812. Networking device 834 may communicate the return information to processor 836 via communication channel 842. Processor 846 may communicate the return information to GUI 838 via communication channel 844. User may then view the return information on GUI 838.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation:

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing managing provision of services according to the present invention will be apparent to those skilled in the art. Various aspects of the invention have been described above by way of illustration, and the specific embodiments disclosed are not intended to limit the invention to the particular forms disclosed. The particular implementation of the managing provision of services may vary depending upon the particular context or application. By way of example, and not limitation, the managing provision of services described in the foregoing were principally directed to electronic implementations; however, similar techniques may instead be applied to physical delivery services, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A method comprising the steps of:
placing a reservation request for a service for a recipient, the reservation request being communicated to a server, the server being configured to be operable to select a provider from a group of providers associated with the recipient, the server being further configured to determine that a selected provider satisfies guidelines of the reservation, communicate the reservation request to a selected provider satisfying the guidelines, select another provider upon rejection of, or a failure to accept, the reservation request by the selected provider, and provide notification of acceptance of the reservation request; and
receive the notification from the server.

2. The method as recited in claim 1, in which the server is further configured to apply a selected algorithm associated with the associated provider during selection of the selected provider.

3. The method as recited in claim 2, in which the selected algorithm is preselected by the associated provider.

4. The method as recited in claim 1, in which the group comprises at least one provider linked by the recipient and at least one provider linked by at least one provider in the group.

5. The method as recited in claim 1, in which the recipient is linked to another recipient by an identification.

6. The method as recited in claim 5, in which linked recipients are associated with the provider and linked recipients are associated with the recipient.

7. The method as recited in claim 6, in which the recipient is rewarded at least in part by reservation requests by associated recipients.

8. The method as recited in claim 1, in which the provider is rewarded at least in part by passage of the reservation request to another provider in the group.

9. The method as recited in claim 1, in which the provider priorities selection order within the group.

10. The method as recited in claim 4, in which recipient complaints regarding the linked provider are forwarded to the provider.

11. A system comprising:
at least one client being configured to at least be operable to communicate registration information of a user, communicate identification information for other users to be associated with the user, communicate a reservation request for a service from a recipient user, receive a reservation request for a provider user, communicate a response from the provider user for the reservation request, and receive notification of acceptance of the reservation request for the recipient user; and
a server being configured to at least be operable to receive the registration information and the identification information in which the recipient is linked to another recipient by identification information, and linked recipients are associated with the provider and linked recipients are associated with the recipient, said server being further configured to be operable to receive the reservation request, select a provider from a group of providers associated with the recipient of the reservation request in which the group comprises at least one provider linked by the recipient and at least one provider linked by at least one provider in the group in which the provider priorities selection order within the group, said server being further configured to be operable to apply a selected algorithm associated with the associated provider during selection of the selected provider in which the selected algorithm is preselected by the associated provider, said server being further configured to determine that a selected provider satisfies guidelines of the reservation, communicate the reservation request to a selected provider satisfying the guidelines, select another provider upon rejection of, or a failure to accept, the reservation request by the selected provider, and provide notification of acceptance of the reservation request, in which the recipient is optionally rewarded at least in part by reservation requests by associated recipients, the provider is optionally rewarded at least in part by passage of the reservation request to another provider in the group, and recipient complaints regarding the linked provider are forwarded to the provider.

12. A non-transitory computer-readable storage medium with an executable program stored thereon, wherein the program instructs one or more processor to perform the following steps:
placing a reservation request for a service for a recipient, the reservation request being communicated to a server, the server being configured to be operable to select a provider from a group of providers associated with the recipient, the server being further configured to determine that a selected provider satisfies guidelines of the reservation, communicate the reservation request to a selected provider satisfying the guidelines, select another provider upon rejection of, or a failure to accept, the reservation request by the selected provider, and provide notification of acceptance of the reservation request; and
receive the notification from the server.

13. The program instructing the processor as recited in claim 12, in which the server is further configured to apply a selected algorithm associated with the associated provider during selection of the selected provider.

14. The program instructing the processor as recited in claim 13, in which the selected algorithm is preselected by the associated provider.

15. The program instructing the processor as recited in claim 12, in which the group comprises at least one provider linked by the recipient and at least one provider linked by at least one provider in the group.

16. The program instructing the processor as recited in claim 12, in which the recipient is linked to another recipient by an identification.

17. The program instructing the processor as recited in claim 16, in which linked recipients are associated with the provider and linked recipients are associated with the recipient.

18. The program instructing the processor as recited in claim 17, in which the recipient is rewarded at least in part by reservation requests by associated recipients.

19. The program instructing the processor as recited in claim 12, in which the provider is rewarded at least in part by passage of the reservation request to another provider in the group.

20. The program instructing the processor as recited in claim 12, in which the provider priorities selection order within the group.
